(19) United States
(12) Patent Application Publication
(10) Pub. No.: US 2023/0253666 A1
(43) Pub. Date: Aug. 10, 2023

(54) INTEGRATED VALVE PLUG AND BATTERY INCLUDING THE SAME

(71) Applicant: CPS Technology Holdings LLC, New York, NY (US)

(72) Inventors: Rengaraj Balakrishnan, Menomonee Falls, WI (US); Jason D. Fuhr, Sussex, WI (US); Tyler Anthony Thiel, Germantown, WI (US); Remy Celine Boudousquie, Houston, TX (US)

(21) Appl. No.: 18/012,596

(22) PCT Filed: Jun. 25, 2021
(86) PCT No.: PCT/US2021/039125

§ 371 Date: Dec. 22, 2022

Related U.S. Application Data
(60) Provisional application No. 63/044,657, filed on Jun. 26, 2020.

(51) Int. Cl. H01M 50/325; H01M 50/367; H01M 50/383; H01M 10/12

(52) U.S. Cl. CPC H01M 50/325; H01M 10/121; H01M 50/367; H01M 50/383; H01M 2200/20

(57) ABSTRACT

An integrated-valve plug to be placed in a channel for conveying a gas is disclosed. The integrated-valve plug comprises a plug body having an opening for receiving the gas from the channel, and having a plug chamber. The integrated-valve plug further comprises a valve, a flame arrester, and a cap disposed in the plug chamber. The cap includes an aperture for exhausting the gas from the plug body. The integrated-valve plug further comprises a gas path defined in part from the opening, past the valve, through the flame arrestor, and through the aperture.

A battery is also disclosed. The battery includes a first cell compartment, a second cell compartment, a first plug for the first cell compartment, and a second plug for the second cell compartment. The first plug includes a first plug chamber and a first plug outlet in fluid communication with the first plug chamber. The first plug chamber receives a first gas from the first cell compartment and exhausts the first gas via the first plug outlet. The second plug includes a second plug chamber and a second plug outlet in fluid communication with the second plug chamber. The second plug chamber receives a second gas from the second cell compartment and exhausts the second gas via the second plug outlet. The battery further comprises a degassing channel coupled to receive the first gas from the first plug outlet and to receive the gas from the second plug outlet, and a valve plug coupled to receive a gas including at least portions of the first gas and the second gas from the degassing channel. The valve plug controllably exhausts the gas. The valve plug can include the integrated valve plug comprising the valve and the flame arrestor to take further advance of the integrated valve plug.

### RELATED APPLICATIONS

This application claims the benefit of U.S. Provisional Pat. Application, No. 63/044,657; filed Jun. 26, 2020; entitled “INTEGRATED VALVE PLUG AND BATTERY INCLUDING THE SAME”, the entire content of which is hereby incorporated by reference herein in its entirety.

### FIELD

This application relates to valves and flame arrestors. More specifically, this application relates to a battery, such as an absorbent glass mat (AGM) battery, having a valve and a flame arrestor.

### BACKGROUND

FIGS. 1A and 1B show a Polypropylene (PP) plug 10 of the prior art. The plug includes an ethylene propylene diene monomer (EPDM) rubber valve 15 having a vent flap 20 that can vent a gas 25 when a pressure of the gas overcomes the tension of the vent flap 20. FIG. 1A shows the plug in a non-venting situation, and FIG. 1B shows the plug in a venting situation.

An AGM battery 30 (FIG. 2) may have a plurality of cells. For example, a known AGM battery 30 may have six cells (cells 1-4 are shown in FIG. 2). The shown AGM battery 30 has one rubber plug of the prior art for each cell to control the pressure inside each cell individually. That is, FIG. 2 shows four of the six cells with a prior art plug and valve of FIGS. 1. FIG. 2 also shows a degassing channel 35 coupling vents of the plurality of plugs to a flame arrestor 40.

Accordingly, the AGM battery 30 of FIG. 2 may result in cell-to-cell variation due to the valves in each cell releasing pressure at different times. Also, the AGM batteries 30 of FIG. 2 results in six plugs with six valves and two flame arrestors 40. Another alternative solution addressing one or more of the above deficiencies and/or other deficiencies is desired.

### SUMMARY

In at least one implementation, an integrated-valve plug to be placed in a channel for conveying a gas is disclosed. The integrated-valve plug comprises a plug body having an opening for receiving the gas from the channel, and having a plug chamber. The integrated-valve plug further comprises a valve disposed in the plug chamber, a flame arrestor disposed in the plug chamber, and a cap disposed in the plug chamber. The cap includes an aperture for exhausting the gas from the plug body. The integrated-valve plug further comprises a gas path defined in part from the opening, past the valve, through the flame arrestor, and through the aperture. The integrated-valve plug design combines the functionality of the flame arrester and the valve in a single component. In one construction, the valve is a flap valve. In another construction the valve is an umbrella valve. Other valve types are envisioned in additional constructions.

In at least another implementation, a battery is disclosed. The battery includes a first cell compartment, a second cell compartment, a first plug for the first cell compartment, and a second plug for the second cell compartment. The first plug includes a first plug chamber and a first plug outlet in fluid communication with the first plug chamber. The first plug chamber receives a first gas from the first cell compartment and exhausts the first gas via the first plug outlet. The second plug includes a second plug chamber and a second plug outlet in fluid communication with the second plug chamber. The second plug chamber receives a second gas from the second cell compartment and exhausts the second gas via the second plug outlet. The battery further comprises a degassing channel coupled to receive the first gas from the first plug outlet and to receive the gas from the second plug outlet, and a valve plug coupled to receive a gas including at least portions of the first gas and the second gas from the degassing channel. The valve plug controllably exhausts the gas. This new battery helps to remove the individual cell valves from each cell of the prior art to create a common headspace with equal pressure for the first and second cell compartments. The valve plug can include the integrated valve plug comprising the valve and the flame arrestor to take further advantage of the integrated valve plug.

### BRIEF DESCRIPTION OF THE DRAWINGS

FIG. 1 is a sectional view of a rubber plug of the prior art. FIG. 1A shows a valve of the rubber plug in a non-venting situation, and FIG. 1B shows the valve of the rubber plug in a venting situation.

FIG. 2 is a sectional view of a portion of a prior art battery.

FIG. 3 is a perspective view of a battery capable of incorporating one or more aspects of the invention.

FIG. 4 is a perspective view of the battery of FIG. 3 with a cover removed.

FIG. 5 is a perspective view of the battery of FIG. 3 with a partially exploded view of a cell of the battery.

FIG. 6 is a sectional view of a partially complete battery assembly of FIG. 3 with an electrolyte being injected into the plurality of cells.

FIG. 7 is a side view of a polypropylene plug capable of being inserted in the injection apertures of the partially complete battery assembly of FIG. 6.

FIG. 8 is a side-sectional view of a portion of the battery of FIG. 3.

FIG. 9 is a top-sectional view of a portion of the battery of FIG. 3.

FIG. 10 is a perspective view of an integrated valve plug shown in FIG. 8.

FIG. 11 is a sectional view of the integrated valve plug of FIG. 10.

FIG. 12 is an exploded view of the integrated valve plug of FIG. 10.

FIG. 13 is a sectional view of a second integrated valve plug capable of being used in the battery of FIG. 8.

FIG. 14 is an exploded view of the second integrated valve plug of FIG. 13.

FIG. 15 is a sectional view of a third integrated valve plug capable of being used in the battery of FIG. 8.

FIG. 16 is an exploded view of the third integrated valve plug of FIG. 15.

FIG. 17 is a sectional view of a plug body for the third integrated valve plug of FIG. 15.

FIG. 18 is a side view of the plug body of FIG. 17.

FIG. 19 is a perspective view of a cover for the third integrated valve plug of FIG. 15.

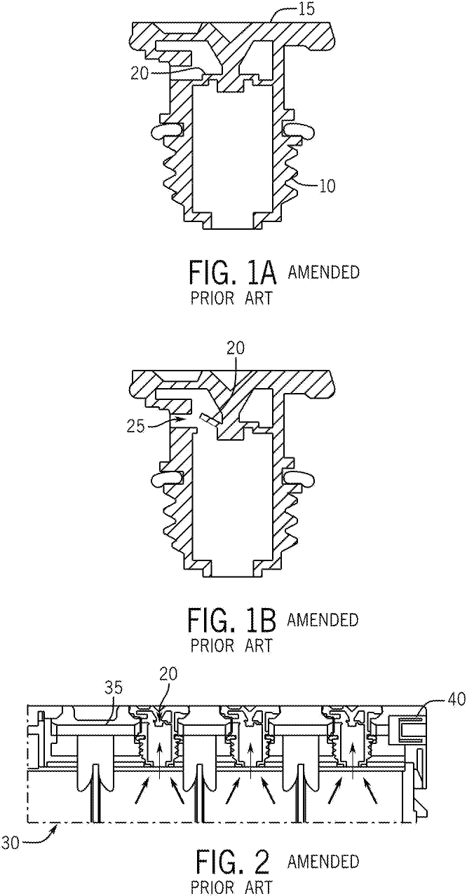

It should be understood that the drawings are not necessarily to scale. In certain instances, details that are not necessary to the understanding to the invention or render other details difficult to perceive may have been omitted. It should be understood, of course, that the invention is not necessarily limited to the apparatus or processes illustrated herein.

### DETAILED DESCRIPTION

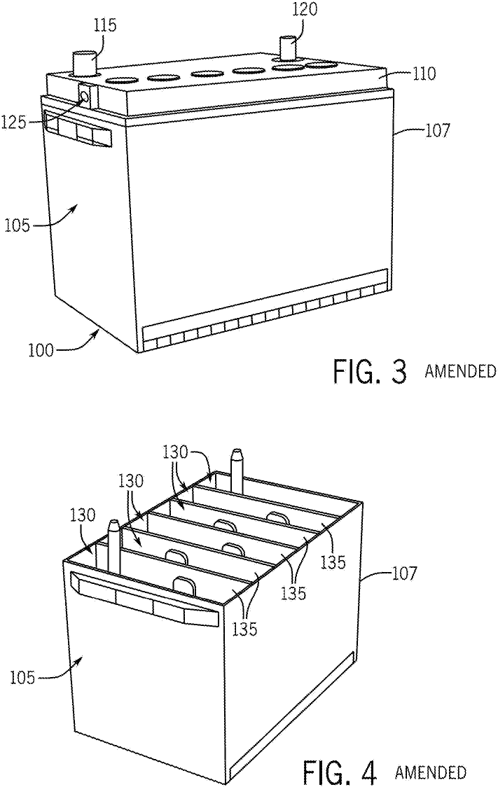

FIG. 3 shows a battery 100 (e.g., a lead-acid battery for use with vehicles or other applications, including starting, lighting, and ignition batteries; a commercial battery; an industrial battery; a marine battery; etc.) having a housing 105. The housing 105 includes a base 107 and a cover 110. The cover 110 is secured to the base 107 (e.g., by heat sealing the cover 110 to the base 107 at various points). The battery 100 further includes terminals 115 and 120 (or bushings) protruding through or on the housing 105 (e.g., the cover 110 as shown), and a vent aperture 125 for venting gas from a venting system (discussed below). The terminals 115 and 120 are provided on the cover 110 for connecting or coupling the battery 100 to electrical loads (e.g., a vehicle electrical system, etc.)

FIG. 4 shows the cover removed. The housing 105 supports a plurality of battery cell compartments 130. The cell compartments 130 can be formed by the housing 105 and a plurality of cell walls or partitions 135 that define the plurality of cell compartments 130. The partitions 135 may be formed with the housing 105. While the construction discussed herein has six cell compartments, a different number of compartments may be provided. Further, while the shown cell compartments 130 are generally rectangular in cross-sectional shape, other shapes may be used for the compartments. The cell compartments 130 (and related battery cells) may conventionally be referred to by number (e.g., a six-cell battery would have cells 1, 2, 3, 4, 5, and 6). According to an example construction in which a battery 100 is provided as having six cells, five partitions are provided, one of which is provided between each of the six cells.

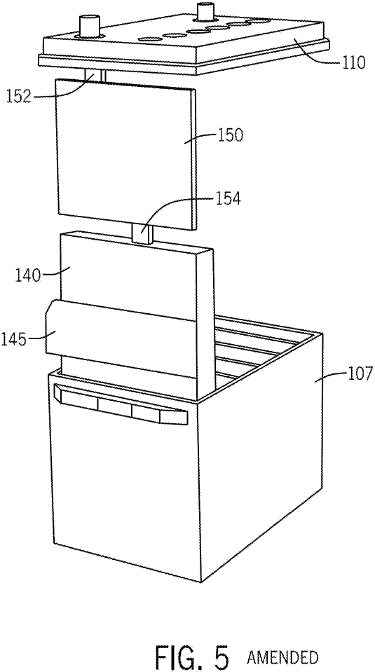

FIG. 5 shows one of a plurality of battery cells in a partially-exploded view. The battery cell includes a plurality of positive frames, a plurality of separators partially surrounding the positive frames, and a plurality of negative frames. FIG. 5 has one positive frame 140, one separator 145, and one negative frame 150 labelled.

In a lead-acid battery, the positive and negative plates each comprise a lead or lead alloy grid that serves as a substrate and supports an electrochemically active material deposited or otherwise provided thereon during manufacture to form the battery plates. The grids provide an electrical contact between the positive and negative active materials or paste which serves to conduct current. Separators may be provided between the plates to prevent shorting and/or undesirable electron flow produced during the reaction occurring in the battery 100. Positive and negative electrode plates can be classified into various types according to the method of manufacturing. In one or more examples, each plate has a generally rectangular shape and includes a lug 152/154 which is electrically coupled to a battery terminal 115 or 120. The plate also may include side walls, a bottom edge, and opposing faces.

The one or more battery separators are used to conductively separate the positive and negative electrodes. A separator material, utilized to separate adjacent plates from one another, has sufficient porosity and retention to contain at least substantially all of the electrolyte necessary to support the electrochemical reactions. In various examples, the separator material is compressible so that upon stacking of the elements, the separator material substantially conforms to the contour of the surface of the plates to help it perform its wicking or capillary action.

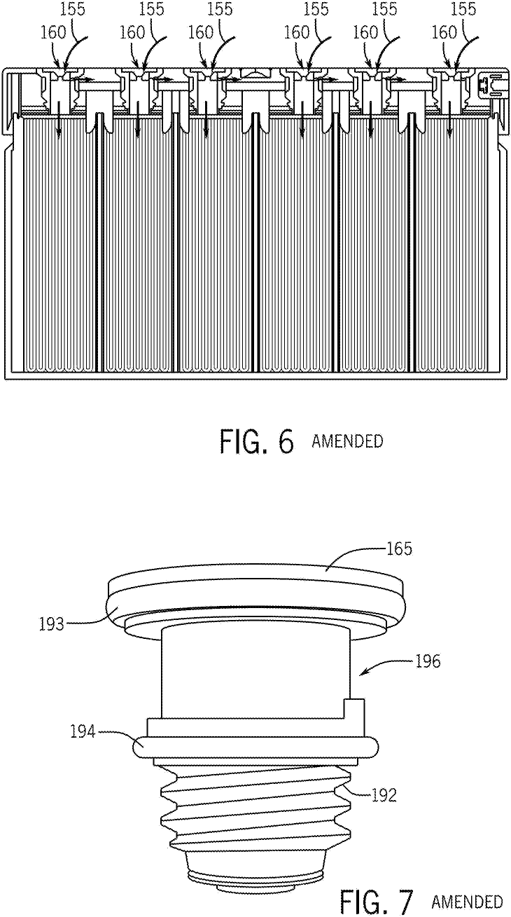

In one or more examples, the separator may be similar in design and/or construction to that previously used for sealed lead-acid batteries operating on the oxygen recombination principle, in particular separators of a highly porous mat of ultrafine glass fibers. For example, in various examples, the separator is constructed of an absorbent glass mat (AGM). In various examples, the AGM is a non-woven fabric including glass micro-fibers that are intended to retain electrolyte (e.g., by capillary action) but also provide gas spaces as long as the grid is not fully saturated with electrolyte. The electrolyte is still free to move but is more confined than in a flooded cell. FIG. 6 shows an electrolyte 155 being injected through apertures 160 of the cover 110.

Before proceeding to the remaining figures, the battery design discussed thus far in FIGS. 3-6 is an example type of battery that can incorporate one or more aspects of the invention. A person of ordinary skill in the battery art would understand that other battery types, designs, and/or arrangements known to those in the battery art can use or incorporate one or more aspects of the invention.

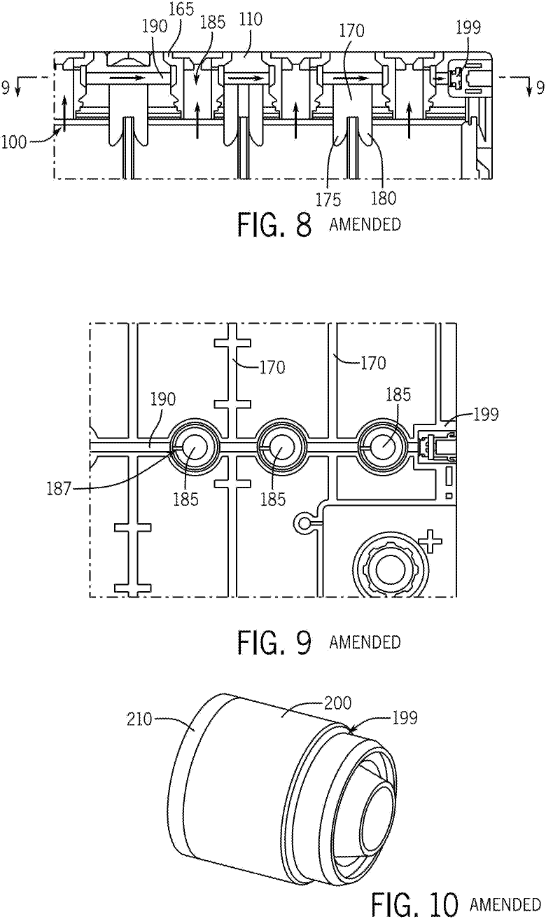

FIG. 7 shows a plug 165 that can be inserted in the aperture of the cover 110. FIG. 8 shows a side-sectional view of a portion of the battery 100 having a plurality of plugs 165. FIG. 9 shows a top-sectional view of a portion of the battery 100 having the plurality of plugs 165. The battery 100 has a plurality of cells (cells 1-4 of six cells are shown). The cover 110 can also include a number of walls or partitions (one partition 170 is labelled in FIG. 8) extending from a surface of the cover 110. Partitions 170 in the cover 110 are provided such that they are aligned with partitions 135 of the cell compartments 130 when the cover 110 is coupled to the base 107 to form finished cell compartments 130. Fingers 175 and 180 may be used to help guide the cover 110 with the base 107. During a heat-sealing operation in which the cover 110 is secured to the base 107, partitions 170 are aligned with partitions 135 and sealed thereto. Accordingly, each of the cells of the battery 100 are isolated from one another (except for the degassing channel discussed below) utilizing partitions 135 and 170 provided in the housing 105.

The battery 100 shown in FIG. 8 has one plug for each cell, respectively (plug 165 is labelled). Each plug 165 has a cavity or plug chamber 185 for a gas to flow from the cell (e.g., cell 3) into the plug chamber 185 and through a plug outlet 187 into a degassing channel 190. The plug 165 can be manufactured from plastic resin, such as polypropylene. The degassing channel 190 allows gasses (shown with arrows) to flow from the cell, into the plug chamber 185, through the plug outlet 187, and into the degassing channel 190. The degassing channel 190 includes a path from one plug 165 to the adjacent plug(s) and a path around each plug. As best shown in FIG. 7, the plug 165 incudes threads 192 for securing the plug 165 into the cover 110, O-rings 193 and 194 for providing a compression fit for further sealing the plug with respect to the degassing channel 190, and a gutter 196 for promoting the degassing channel 190 around the plug 165. The plug 165 cells and degassing channel 190 allows for a common headspace, which helps equalize the pressure on all six cells.

An integrated valve plug 199 is coupled to the end of the degassing channel 190. FIG. 8 shows a single integrated valve plug, but it is envisioned that the battery 100 may include a redundant, second integrated valve at the other end of the degassing channel 190 (e.g., at the end of cell 6). The plug 165 and the integrated valve plug 199 allow for the removal of the six valves of the prior art (e.g., of the AGM battery 30 of FIG. 2) from each cell and use one or two integrated valve plugs 199. The resultant is the common headspace with equal pressure for all six cells until the exhaust of the integrated valve plugs.

Before proceeding further, it is noted that the degassing channel 190 and the location(s) of one or more integrated valve plugs can vary from what has been described. For example, intermediary integrated valve plugs can create a common headspace for two or more cell compartments but less than all of the cell compartments. In this arrangement, the intermediary integrated valve plugs 199 may not be located at the end of the degassing channel 190. It is also envisioned that the integrated valve plug can be placed at an intermediate location of the degassing channel 190 in a “T” arrangement, with the exhaust then proceeding towards multiple ends of the degassing channel.

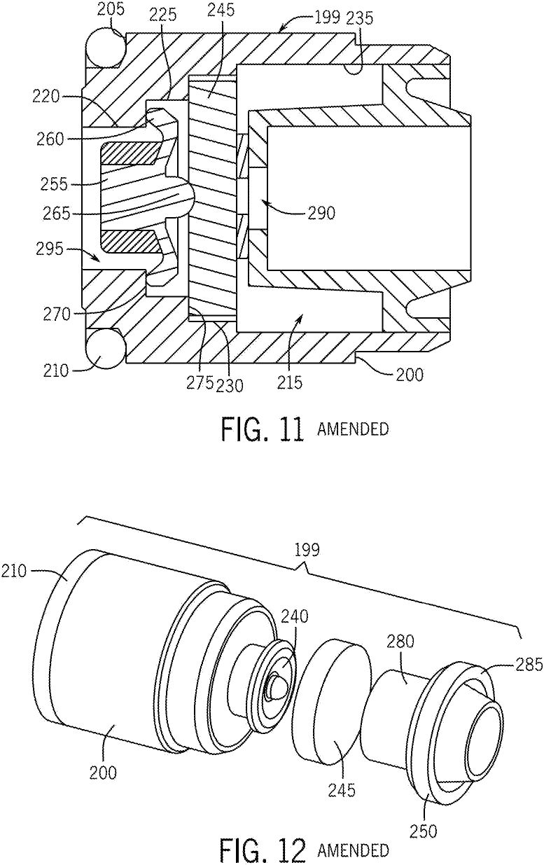

FIGS. 10-12 show the integrated valve plug 199 in more detail. The integrated valve plug 199 combines the functionality of a flame arrestor and an AGM valve into a single component. With reference to FIGS. 10-12, the integrated valve plug 199 includes a plug body 200, a shelf 205, and an elastic O-ring 210 supported by the shelf 205. The elastic O-ring 210 provides an elastic compression fit between the integrated valve plug 199 and the housing 105 (e.g., the cover 110). The O-ring 210 helps to prevent gas from seeping between the integrated valve plug 199 and the housing 105. The O-ring 210 represents a functional seal between the integrated valve plug 199 and the cover 110. An O-ring is one solution, but it may be a molded rib, multiple molded ribs, or a flap. The seal with the cover can be created using further or other welding options, such as sonic welding or heat-seal as well.

Within the plug body 200 is a multi-level chamber 215. Each level has a wall 220-235 with a different radius from the center of the chamber 215. Housed within the multi-level chamber 215 is a valve 240, a flame arrestor 245, and a plug sleeve or cap 250. The valve 240 can be a flap valve.

The valve 240 includes a body 255, a lip flange 260, and a nipple 265. The body 255 mostly abuts the first level of the chamber 215 and the lip flange 260 abuts a wall 270 between the first wall 220 and the second wall 225 of the chamber 215.

The flame arrestor 245 abuts the third wall 230 of the chamber 215 and the wall 275 between the second wall 225 and the third wall 230 of the chamber 215. The flame arrestor 245 is or comprises an ignition protection frit made of flame-retardant material. The flame-retardant material can be, for example, a sintered resin or metal material, like polypropylene, brass, or aluminum. According to one or more constructions, the flame arrestor 245 element thickness is less than 12 mm, in particular less than 3 mm.

The plug cap 250 includes a body 280 and a cap flange 285. The cap flange 285 abuts the fourth wall 235 of the chamber 215 and the body 280 includes an aperture 290 for gas to flow through. The plug cap 250 is press fit into the plug body 280 during assembly and can be followed by heat sealing. When press fit into the chamber 215, the plug cap 250 presses against the flame arrestor 245, which similarly presses on the nipple 265 of the valve 240. This results in the flame arrestor 245 providing a pretension on the valve 240. It is envisioned, however, that the flame arrester 245 does not provide pretension to the valve 240, and/or, may provide tension or further tension when gas is applied to the valve 240.

The valve 240 also includes a valve chamber 295 in the body 280 and lip flange 260. The valve chamber 295 receives a gas from the degassing channel 190. An increasing pressure in the degassing channel 190 results in an increase pressure on the lip flange 260 from the chamber 295 side of the valve 240. When the pressure of the gas in the chamber 295 pushing on the lip flange 260 is greater than the pretension or tension of the flame arrestor on the nipple 265, the gas is allowed to vent past the valve 240, through the flame arrestor, and through the aperture 290 of the plug cap 250. In one example construction, the pressure may be between 50 and 400 mbar. In another construction, the operating range may be smaller. It is also noted that the cross-sectional shape of the integrated valve plug 199 and its components are circular. It is envisioned, however, that other shapes are possible in alternative to the circular construction shown.

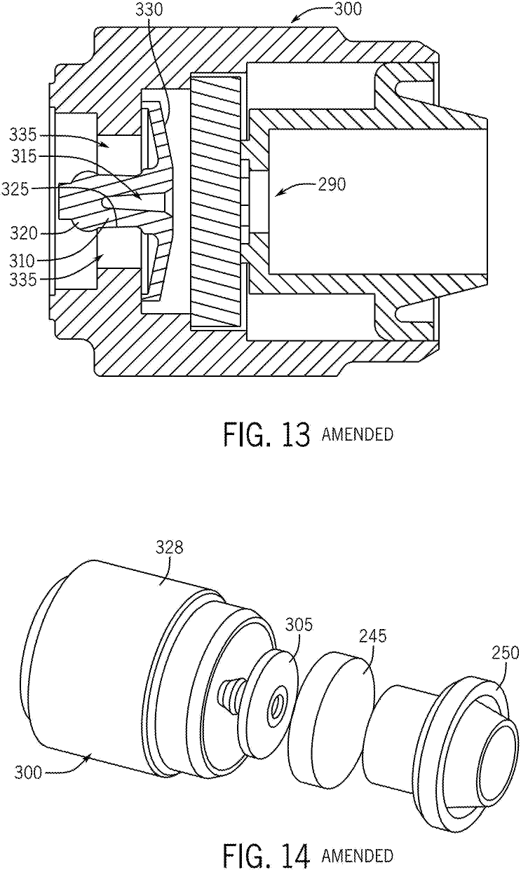

FIGS. 13 and 14 shows a second integrated valve plug 300 in more detail. This version of the second integrated valve plug 300 includes an umbrella valve 305 in place of the valve 240. The umbrella valve is made of an elastic material such as ethylene propylene diene monomer (EPDM) rubber. The umbrella valve 305 includes a pole 310 having a chamber 315 and an integrated ring 320. The chamber 315 and integrated ring 320 help for inserting and holding the umbrella valve 305 in an aperture 325 of the body 328. The umbrella valve 305 also includes a canopy 330.

The plug body 328 includes one or more channels 335 for gas to flow through and apply pressure to the canopy of the umbrella valve 305. When the pressure of the gas in the chamber 315 pushing on the canopy is greater than the elasticity of the umbrella valve 305, the gas is allowed to vent past the umbrella valve 305, through the flame arrestor 245, and through the aperture 325 of the plug cap 250. Accordingly, the second integrated valve plug 300 does not require pretension or tension from the flame arrestor 245, thereby limiting damage to the flame arrestor 245.

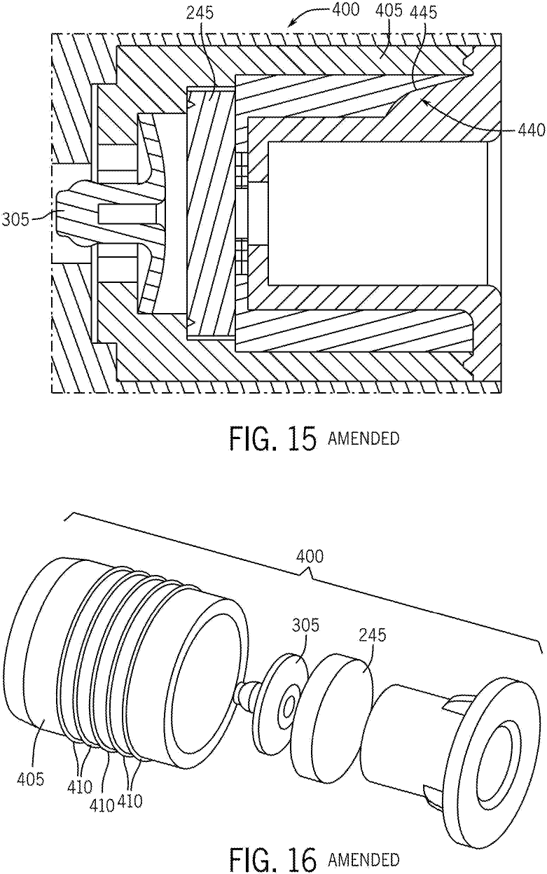

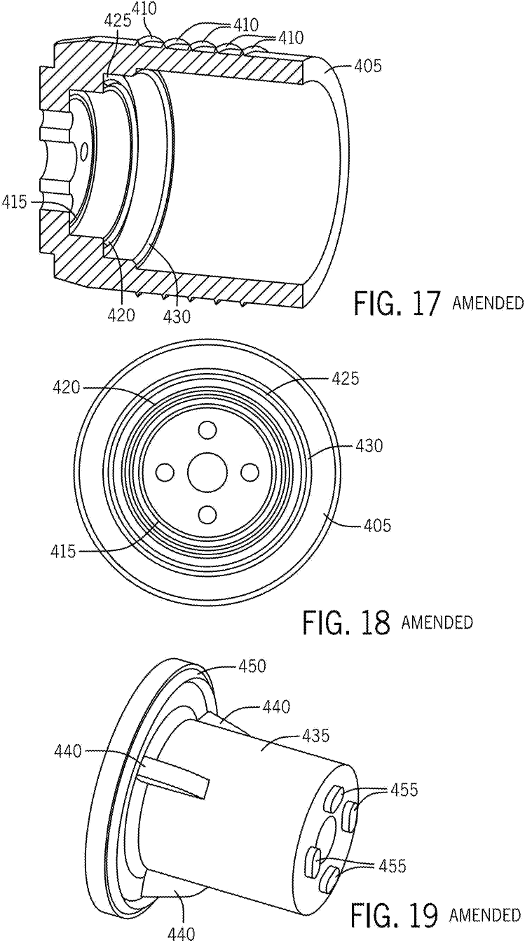

FIGS. 15-19 shows a third integrated valve plug 400 in more detail. This version of the third integrated valve plug 400 includes the umbrella valve 305. For the shown valve plug 400, the plug body 405 includes crush ribs 410 for an interference fit, a first seating surface 415 for the umbrella valve 305 a placement tooth 420 on a second seating surface 425 and an alignment surface 430 for helping to place and secure the flame arrestor 245 when inserting the flame arrestor 245 into the plug body 405. The cap 435 incudes alignment ribs 440 for centering and placing the cap 435. The alignment ribs 440 are received by alignment indents 445 (an indent is best shown in FIG. 13). The cap further includes a tooth 450 as an energy concentrator for sonic welding during manufacturing and protrusions 455 for holding the flame arrestor 245 in place.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further and unless explicitly noted, the terms and phrases used herein are not intended to be limiting but rather to provide an understandable description of possible implementations. Various implementations are shown in the drawings, but the implementations are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of... and ....” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

Aspects herein can be embodied in other forms without departing from the spirit or essential attributes thereof. Accordingly, reference should be made to the following claims, rather than to the foregoing specification, as indicating the scope hereof.

1. An integrated-valve plug to be placed in a channel for conveying a gas, the integrated-valve plug comprising:
a plug body having
an opening for receiving the gas from the channel, and
a plug chamber;
a valve disposed in the plug chamber;
a flame arrestor disposed in the plug chamber;
a cap disposed in the plug chamber, the cap having a tooth and including an aperture for exhausting the gas from the plug body; and
a gas path defined in part from the opening, past the valve, through the flame arrestor, and through the aperture.

2. The integrated-valve plug of claim 1, wherein the flame arrestor is disposed between the valve and the cap along the gas path.

3. The integrated-valve plug of claim 1, wherein the valve includes a flap valve.

4. (canceled)

5. (canceled)

6. The integrated-valve plug of claim 3, wherein the flap valve includes a body and a flange defining a valve chamber, wherein the valve chamber receives at least a portion of the gas from the channel, and wherein the flap valve releases the gas from the valve chamber when a pressure on the flange is greater than a tension.

7. The integrated-valve plug of claim 1, wherein the valve includes an umbrella valve.

8. The integrated-valve plug of claim 7, wherein the umbrella valve comprises an elastic material.

9. The integrated-valve plug of claim 7, wherein the umbrella valve comprises a pole and an integrated ring, wherein the plug body includes a wall having a second aperture, wherein the second aperture holds the pole and the integrated ring abuts the wall.

10. The integrated-valve plug of claim 9, wherein the wall includes a third aperture, wherein the third aperture receives at least a portion of the gas from the channel, and wherein the umbrella valve releases the portion of gas through the third aperture when a pressure on the umbrella valve is greater than a tension.

11. The integrated-valve plug of claim 1, wherein the plug body further includes an outer surface having a plurality of ribs.

12. The integrated-valve plug of claim 1, wherein the plug body further includes an alignment indent, and wherein the cap includes an alignment rib disposed in the alignment indent.

13. (canceled)

14. A battery comprising:
a first cell compartment;
a second cell compartment;
a first plug for the first cell compartment, the first plug including a first plug chamber and a first plug outlet in fluid communication with the first plug chamber, the first plug chamber receiving a first gas from the first cell compartment and exhausting the first gas via the first plug outlet;
a second plug for the second cell compartment, the second plug including a second plug chamber and a second plug outlet in fluid communication with the second plug chamber, the second plug chamber receiving a second gas from the second cell compartment and exhausting the second gas via the second plug outlet;
a degassing channel coupled to receive the first gas from the first plug outlet and to receive the second gas from the second plug outlet;
the degassing channel having a path for a transfer of a gas including: at least portions of the first gas and the second gas between the first plug and the second plug; and
a valve plug coupled to receive the gas from the degassing channel and to controllably exhaust the gas.

15. The battery of claim 14 wherein the valve plug is an integrated-valve plug comprising a valve and a flame arrestor.

16. The battery of claim 14, wherein the degassing channel includes a first end and a second end, wherein the valve plug is disposed at the first end and, and wherein the battery further comprises a second valve plug disposed at the second end coupled to receive the gas including at least portions of the first gas and the second gas from the degassing channel and to controllably exhaust the gas.

17. The battery of claim 14, wherein the degassing channel includes a first end and a second end, wherein the valve plug is disposed in the degassing channel, and wherein the gas exhausted from the valve plug is provide to the first end, the second end, or both the first end and the second end.

18. The integrated-valve plug of claim 1, wherein the tooth is an annular tooth.

19. The integrated-valve plug of claim 18, wherein the annular tooth is an energy concentrator for sonic welding the cap to the plug chamber.

20. The integrated-valve plug of claim 1, further comprising a placement tooth on a second seating surface of the plug body for an encouragement of a placement of the flame arrestor.

21. The integrated-valve plug of claim 20, further comprising an alignment surface of the plug body for the encouragement of the placement of the flame arrestor.

22. The battery of claim 14, wherein the degassing channel has a second path for a movement of the gas circumventing a plug.
